(19) United States
(12) Patent Application Publication
(10) Pub. No.: US 2011/0000267 A1
(43) Pub. Date: Jan. 6, 2011

(54) LOCK KEY MECHANISM

(76) Inventor: Antonio Domit, San Antonio, TX (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 12/726,132

(22) Filed: Mar. 17, 2010

(30) Foreign Application Priority Data
Mar. 19, 2009 (MX) MX/A/2009/002955

(51) Int. Cl. E05B 11/00

(52) U.S. Cl. 70/389

(57) ABSTRACT

A locking mechanism wherein it is possible to fix the key inside the lock outphased from the original combination, thereby preventing the cylinder of the lock from turning. The security of the locking mechanism is also enhanced as the key cannot be expelled from the lock. Therefore it is impossible to insert any other key or picklock.

### PRIORITY CLAIM

This application is based on and claims the benefit of priority from Mexican Patent Application No. MX/a/2009/002955 filed on Mar. 19, 2009, the contents of which are incorporated by reference.

### BACKGROUND OF THE INVENTION

Currently, the locking keys address different functions for securing a door by means of a lock with designs differing in the form and size of the same key, as well as the specific type of lock in question, making it necessary to have many different keys for a lock, but at no moment the key is a securing device for the lock but only the means to get access to the opening and/or closing of such lock.

In order to solve the problem of not having a mechanism where the same key becomes a latch to secure the lock, the inventor sought to fix the key within the lock in an incorrect position when so desired, so that the same key prevents the input of another key or picklock and the cylinder gets blocked without the possibility of turning and thus works as a locking device. In this way, such mechanisms securing the key in an advanced or retarded position within the lock, outphased from the proper combination to prevent it from working when so desired, are protected.

It is important to note that if the bolt lock consists of two cylinders, one at the door side and another one at the other side, it is necessary that the key gets further inside from the place where the proper combination with the lock bolts is, and that the tip snaps and prevents the cylinder on the other side from turning. If the bolt lock comprises one single cylinder, the key will be in a forward or retracted position to prevent synchronization of the bolts with the correct combination.

### SUMMARY OF THE INVENTION

This invention relates to being able to fix the key inside the lock outphased from the original combination, so that the cylinder of the lock cannot turn and the key cannot be expelled from the other side preventing the input of any kind of key or picklock.

The purpose of the present invention is to provide a security means different from the already known, through a securing key. It is the same and only key for the lock which, upon being inserted into the cylinder of a conventional bolt lock has a position where it unlocks and locks the lock and an other position where the bolt lock is prevented from unlocking.

### DESCRIPTION OF THE INVENTION

This key furthers the purpose of securing the bolt lock because it can be displaced within the cylinder of the bolt lock and fixed in such way that it does not stop at the proper combination. This can be done by letting the key get inside, be it either more than necessary or less than necessary to prevent the combination with the cylinder, and occupy the chamber, thus preventing another key or picklock from getting in from the other side and opening the lock. The key gets fixed to the bolt lock so it cannot be pushed from the other side. To prevent the securing key from being pushed out of the cylinder, one of the bolts of the bolt lock may fall inside a slot, thus securing and blocking it out of the proper combination of the bolt lock and therefore preventing the cylinder from turning.

This can be accomplished in several ways, two mechanisms in the key are proposed herein, consisting of several moving pieces which are coupled.

### Mechanism 1

It comprises ten moving pieces and three springs, all the pieces mounted on a mounting bracket with the combination of the original key to unlock the bolt lock (FIG. 1).

### BRIEF DESCRIPTION OF THE FIGURES

FIGS. 2 and 3

This is a view showing how the butt end of the key (5) is locked by the T-latch (7) that has not been pressed on. The bolt driver (9) cannot be opened because it is locked with the bolt (4) which, in this position, is at the limit of the slot (detail A), preventing the bolt driver (9) from moving backwards. At this position, the key works as a conventional key.

Upon inserting the key in the lock, it strikes with the butt (3). In this position, the key unlocks or locks the cylinder like a conventional key.

FIG. 4

Upon pressing the T-latch (7) it can get inside the butt (5) and the key (3) is free to slide a little more inside the bolt lock (2), missing the proper combination, bearing, to fix the key (3) and the cylinder from the other side if so desired.

The T-latch (7) has been pressed and thus the key (3) is free to slide a little more inside the bolt lock (2) and so miss the proper combination and at the same time fix the key (3) and the cylinder from the other side if so desired. This is possible because the T-latch (7) can now get inside the butt (5).

By pushing the key further inside, after striking the butt, the locking position is activated. The butt (3) gets fix in place due to the spring 2 (4), while the mounting bracket (8) furthers inside, turning the lever (7) which pushes the key (1). Upon pushing the key a space opens between this one and the bolt driver (2) where the cylinder bolt (13) falls, blocking the key (1) and preventing it from getting out. Because the key (1) is further inside, it can lock the cylinder from the other side if there is one.

FIG. 5

The securing action is accomplished when the key (3) moves inside the bolt lock cylinder and gets blocked by the bolt (15), which prevents it to get out, fixing it outphased from the correct combination, until it is released by the bolt driver (9). The spring 3 (14) is pushing all the key to get it back to its normal position, which is accomplished when the bolt driver (9) is actuated.

Upon pulling the mounting bracket (8), the lever (7) turns in the opposite sense, pushing forward the bolt driver (2). When the cylinder bolt gets out, the key is released.

FIG. 6

Upon pushing the bolt driver (9) the spring (13) is compressed, the bolt (15) is driven out and the key (3) is released. At this moment, the key can be pulled, the spring 3 (14) gets the key back in place, the spring 1 (11) gets the T-latch back in place, restoring the limits of the normal key to open or close the bolt lock with the same key.

### Mechanism 2

This mechanism comprises 12 pieces (FIG. 1) identified in the attached figures, illustrating the different positions of the key.

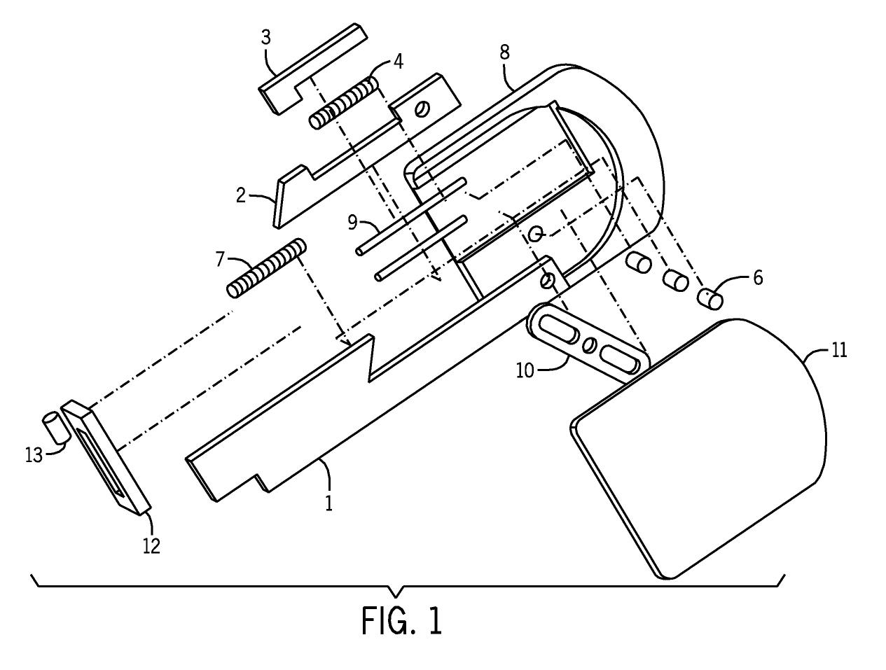

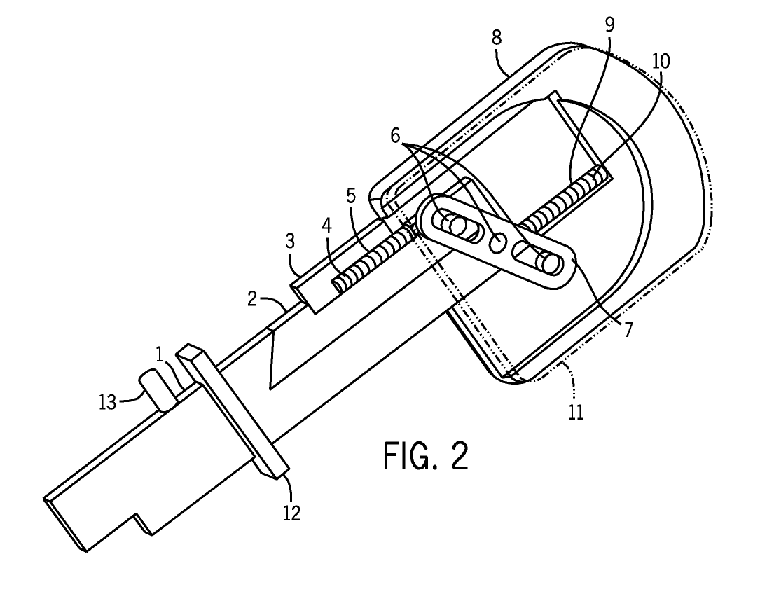

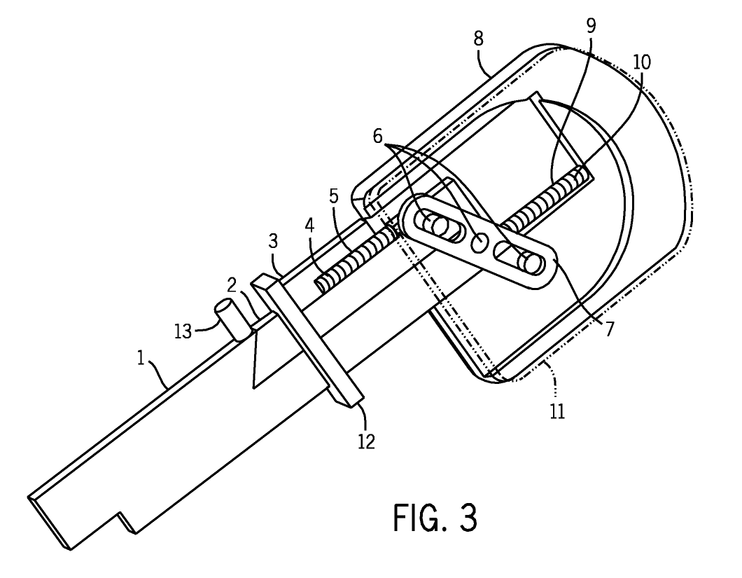

FIGS. 2 and 3

Upon inserting the key in the lock, it strikes with the butt (3). In this position, the key unlocks or locks the cylinder like a conventional key.

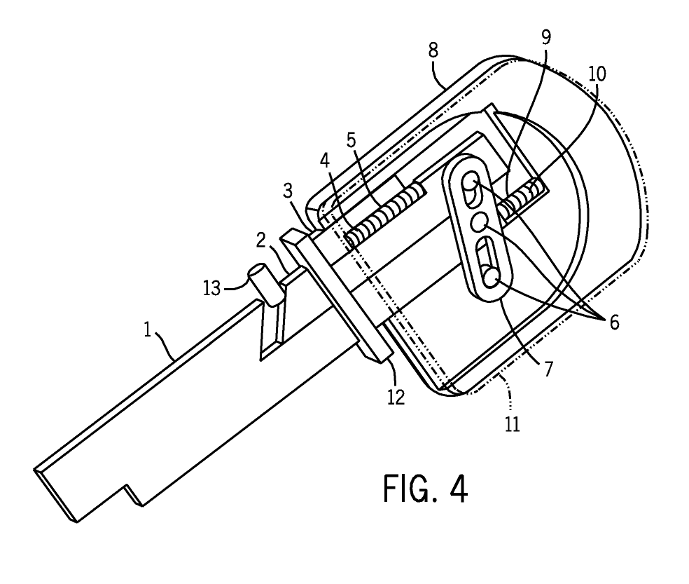

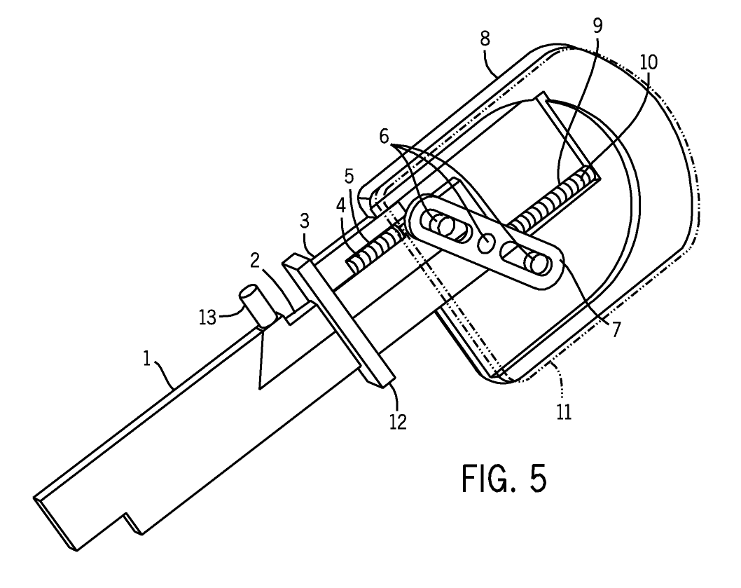

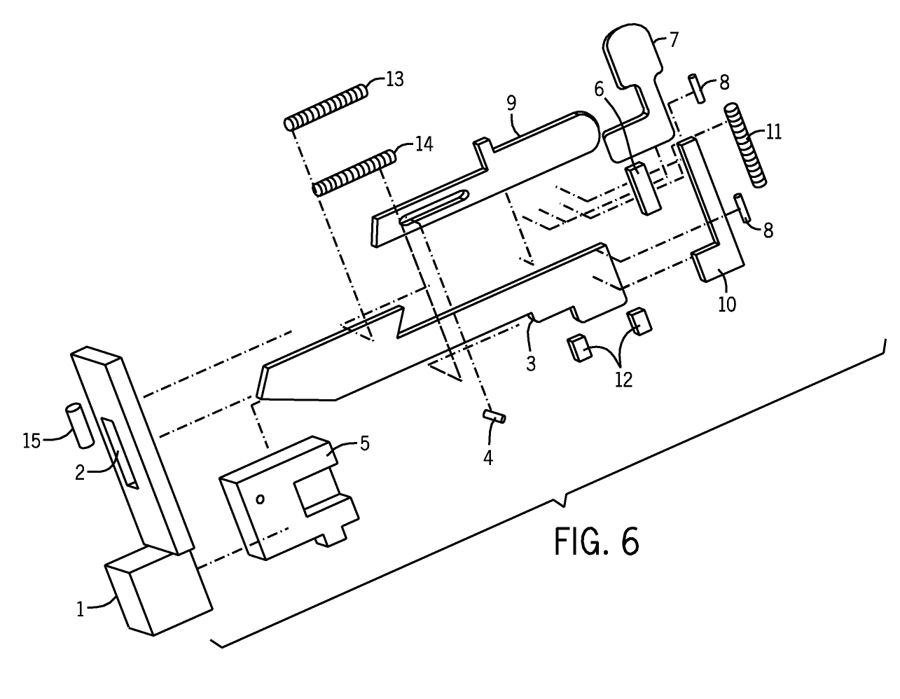

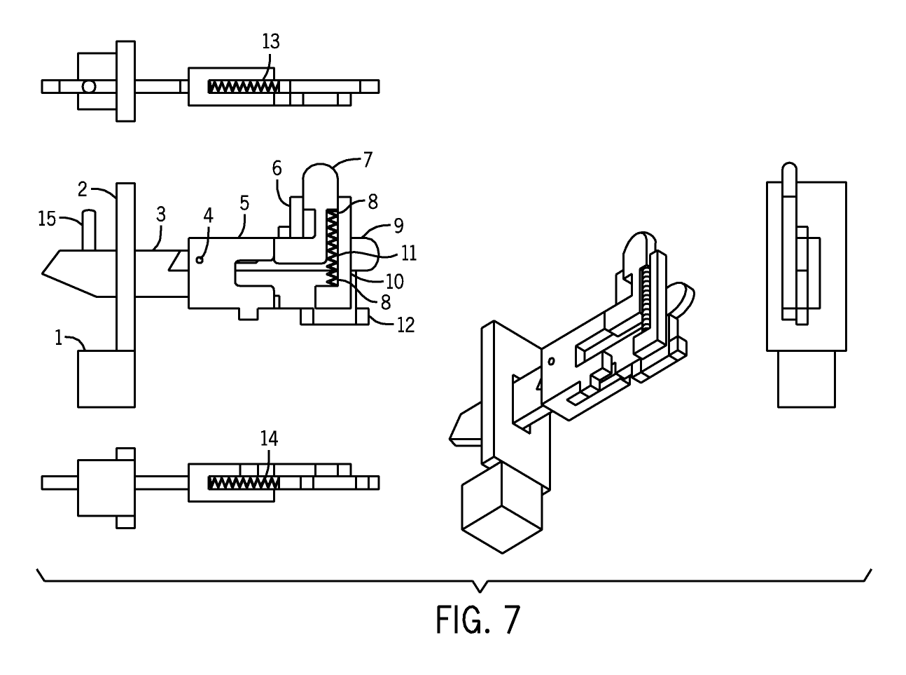

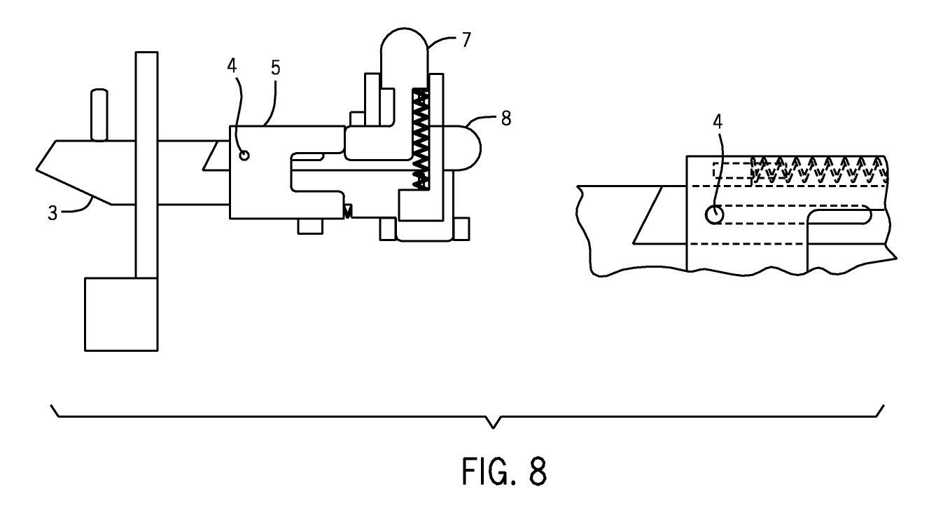

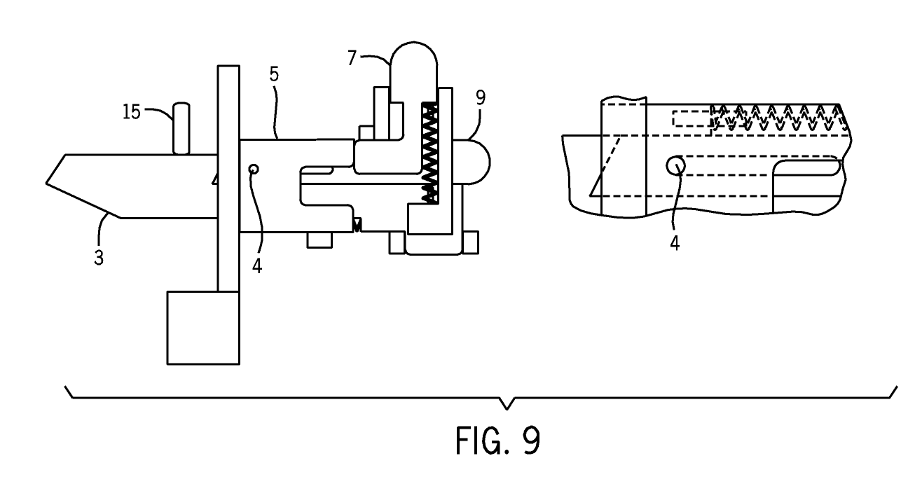

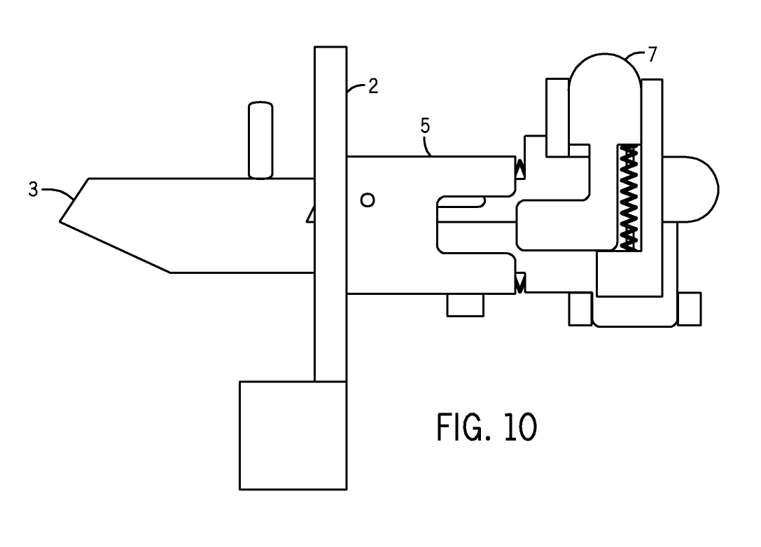

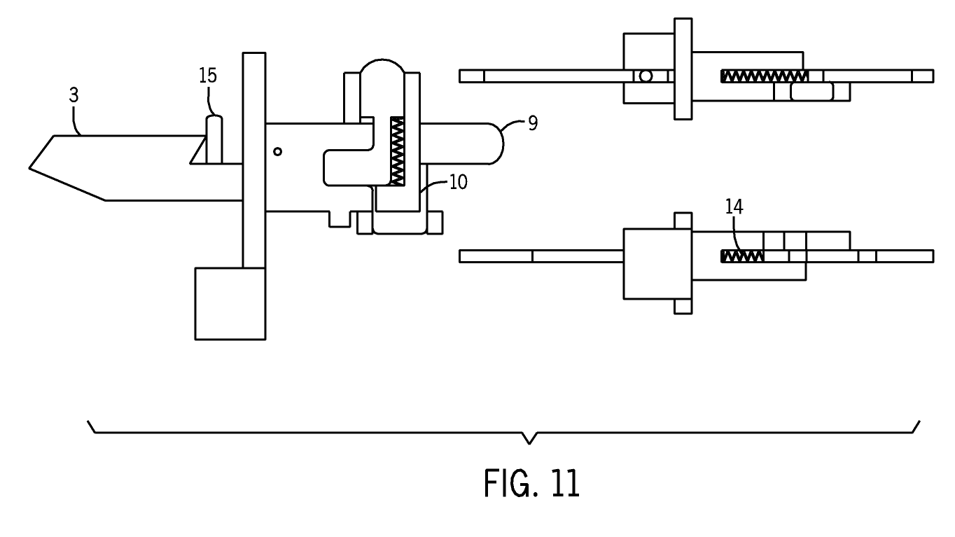

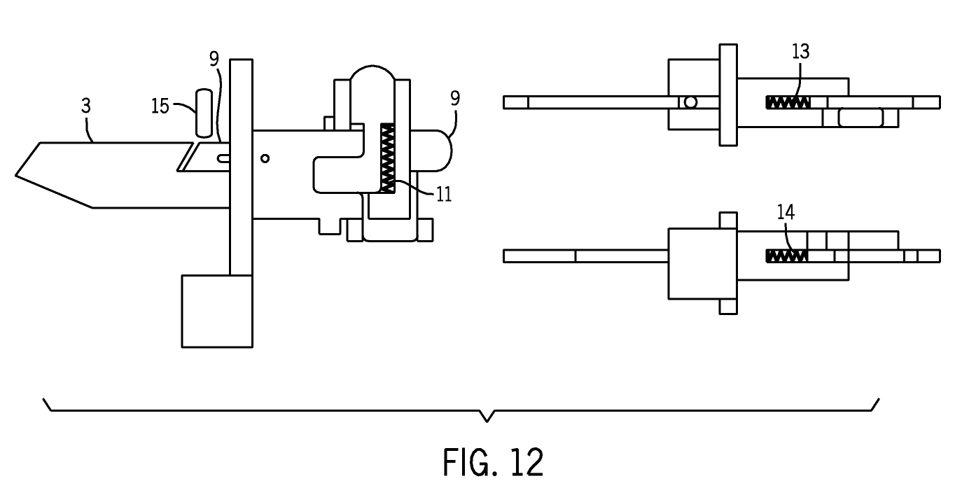

FIG. 4

By pushing the key further inside, after striking the butt, the locking position is activated. The butt (3) gets fix in place due to the spring 2 (4), while the mounting bracket (8) furthers inside, turning the lever (7) which pushes the key (1).

Upon pushing the key a space opens between this one and the bolt driver (2) where the cylinder bolt (13) falls, blocking the key (1) and preventing it from getting out.

FIG. 5

Upon pulling the mounting bracket (8), the lever (7) turns in the opposite sense, pushing forward the bolt driver (2). When the cylinder bolt (13) gets out, the key is released.

Both mechanisms comprise the following parts:
(1) Key: piece with combination,
(2) Bolt driver: drives the bolt out of the bolt lock,
(3) Butt: indicates the position of normal key,
(4) Spring 2: allows actuating of the driver,
(5) Guide pin 2: guides the spring 2,
(6) Axle (three pieces): they fix the lever,
(7) Spring 1: gets everything back to the position of normal key,
(8) Mounting bracket: to hold the key,
(9) Key guide pin: guides the key,
(10) Lever: actuates any of the two mechanisms,
(11) Key cover: covers the key,
(12) Bolt lock: part of the lock,
(13) Cylinder bolt: part of the lock.

Having thoroughly described the invention, I consider it as a novelty and therefore claim as my sole proprietorship the contents of the following claims:

1. Mechanism to allow placing the key in the cylinder of the lock in outphased position from its combination.

2. Mechanism to keep the key fix and blocked inside the cylinder, preventing anything to get inside from the other side of the lock.

3. Securing mechanism by means of a securing key comprising ten moving pieces and three springs mounted on a mounting bracket with the combination of the original key to unlock the bolt lock and a T-latch, according to mechanism 1.

4. Securing mechanism by means of a securing key comprising nine moving pieces and two springs, comprising the combination of the lock key and a lever, according to mechanism 2.
